(19) United States
(12) Patent Application Publication
(10) Pub. No.: US 2024/0065311 A1
(43) Pub. Date: Feb. 29, 2024

(54) CONE ROLLING MACHINE

(71) Applicants: Steven WATTS, North Augusta (CA); ROBOROOTS IP HOLDING LIMITED, Abu Dhabi (AE)

(72) Inventors: Steven Watts, North Augusta (CA); Julio Saborit Gerez, Cuernavaca (MX); Gabriel Gerez Greiser, Cuernavaca (MX)

(73) Assignee: ROBOROOTS IP HOLDING LIMITED, Abu Dhabi (AE)

(21) Appl. No.: 18/263,704

(22) PCT Filed: Jan. 31, 2022
(86) PCT No.: PCT/CA2022/050129

§ 371 Date: Jul. 31, 2023

Related U.S. Application Data
(60) Provisional application No. 63/144,404, filed on Feb. 1, 2021.

(51) Int. Cl. A24C 5/46; B31C 7/02

(52) U.S. Cl. CPC A24C 5/46; B31C 7/02

(57) ABSTRACT

An aspect of the disclosure provides for a cone rolling machine. The cone rolling machine includes a pulling mechanism, a tensioning mechanism, a cutting mechanism, a transport mechanism, a gluing mechanism, and a rolling mechanism. The cone rolling machine is configured to pull paper from a paper source, maintain a consistent tension in the paper, cut a cone blank from the paper, transport the cone blank to a gluing mechanism, apply glue to an edge of the cone blank, and roll the cone blank into a cone. Another aspect of the disclosure provides for a method of making a cone. The method includes pulling paper from a paper source, cutting a cone blank from the paper, transporting the cone blank to a gluing mechanism, applying glue to an edge of the cone blank, transporting the glued cone blank to the rolling mechanism, and rolling the cone blank into a cone.

### CROSS-REFERENCE TO RELATED APPLICATIONS

This patent application claims the benefit of U.S. 63/144,404, filed Feb. 1, 2021, which is incorporated herein by reference in its entirety.

### FIELD OF THE INVENTION

The present invention pertains to the field of rolling machines, and in particular to cone rolling machine.

### BACKGROUND

Existing paper rolling machines are typically designed to roll paper into cylinders or tubes with a consistent diameter. Such rolling machines are generally used for making cigarettes. While cylindrical paper tubes may be used for rolling cannabis, a cone shaped rolled paper is typically preferred. Prior arts offer limited options for a cone shaped paper rolling machine. Existing machines typically require manual intervention to form the cone shape, partly due to the geometry of the cone, having a changing diameter. The changing diameter makes it challenging to develop a machine that on its own can roll a cone shaped rolled paper.

In addition to the geometry of a cone, the type of paper used for rolling cannabis adds a further challenge for developing such a cone rolling machine. Since a thinner paper is used for rolling cannabis than for cigarettes, the manipulation of the paper to form a cone becomes more challenging.

Therefore, there is a need for a cone rolling machine that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An aspect of the disclosure provides for a cone rolling machine. The cone rolling machine includes a pulling mechanism configured to pull paper from a paper source, the paper passing through a tensioning mechanism and a cutting mechanism. The cone rolling machine further includes the tensioning mechanism configured to maintain a consistent tension in the paper as the paper passes through the tensioning mechanism and the cutting mechanism. The cone rolling machine further includes the cutting mechanism configured to cut a cone blank from the paper. The cone rolling machine further includes a transport mechanism configured to receive the cone blank from the cutting mechanism and transport the cone blank to a gluing mechanism and thereafter to a rolling mechanism. The cone rolling machine further includes the gluing mechanism configured to apply glue to an edge of the cone blank. The cone rolling machine further includes the rolling mechanism configured to receive the cone blank from the transport mechanism and roll the cone blank into a cone.

In some embodiments, the cone rolling machine further includes a releasing mechanism configured to receive the cone from the rolling mechanism and release the cone into a collection bin. In some embodiments, the tensioning mechanism comprises a pulley system of at least four pulleys, including three stationary pulleys and a movable pulley configured to create tension. In some embodiments, the cutting mechanism is based on die cutting, wherein the die is a steel rule die. In some embodiments, the transport mechanism uses a pneumatic system for holding the cone blank in a predetermined position during transport. In some embodiments, the transport mechanism transports the cone blank by rotating around an axis. In some embodiments, the gluing mechanism uses a piezo-based valve to apply glue. In some embodiments, the edge of the cone blank is a lagging edge. In some embodiments, the rolling mechanism is a rolling mandrel. In some embodiments, the rolling mandrel uses a pneumatic system to receives the cone blank from the transport mechanism.

Another aspect of the disclosure provides for a method of making a cone. The method includes pulling paper from a paper source, the paper passing through a tensioning mechanism and a cutting mechanism. The method further includes cutting, by the cutting mechanism, a cone blank from the paper. The method further includes receiving, by a transport mechanism from the cutting mechanism, the cone blank. The method further includes transporting, by the transport mechanism, the cone blank to the gluing mechanism. The method further includes applying, by the gluing mechanism, glue to an edge of the cone blank. The method further includes transporting, by the transport mechanism, the cone blank to a rolling mechanism. The method further includes rolling, by the rolling mechanism, the cone blank into a cone.

In some embodiments, the method further includes applying tension to the paper as the paper is being pulled, the tension applied to maintain a consistent tension in the paper. In some embodiments, the method further includes transferring, by the rolling mechanism, the cone to a releasing mechanism. In some embodiments, the method further includes receiving, by the releasing mechanism from the rolling mechanism, the cone. In some embodiments, the method further includes releasing, by the releasing mechanism into a collection bin, the cone. In some embodiments, the cutting includes cutting the cone blank using a die. In some embodiments, the die is a steel-rule die. In some embodiments, the applying includes using a piezo-based valve to apply glue, and the edge of the cone blank is a lagging edge. In some embodiments, the transport mechanism uses a pneumatic system to hold the cone blank during transportation. In some embodiments, the transport mechanism transports the cone blank by rotating about an axis. In some embodiments, the rolling mechanism is a rolling mandrel. In some embodiments, the rolling mechanism uses a pneumatic system to receive from the transport mechanism the cone blank and roll the cone blank into a cone.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a functional diagram of a cone rolling machine, according to an embodiment of the present disclosure.

FIG. 2 illustrates a front view of a cone rolling machine of FIG. 1 assembled according to an embodiment of the present disclosure.

FIG. 3 illustrates a cross sectional view of the tensioning mechanism, according to an embodiment of the present disclosure.

FIG. 4A illustrates an enlarged view of the cutting mechanism of FIG. 2, according to an embodiment of the present disclosure.

FIG. 4B illustrates a cone blank, according to an embodiment of the present disclosure.

FIG. 5A illustrates an enlarged view of FIG. 2 including the cone shoe (the transport mechanism) and other apparatus components, according to an embodiment of the present disclosure.

FIG. 5B illustrates a top view of the cone shoe of FIG. 5A, according to an embodiment of the present disclosure.

FIG. 6 illustrates a top view of the cone shoe's rotation during transport of the cone blank, according to an embodiment of the present disclosure.

FIG. 7 illustrates the cone shoe at the gluing location, according to an embodiment of the present disclosure.

FIG. 8A illustrates a rolling mandrel according to an embodiment of the present disclosure.

FIG. 8B illustrates the cone shoe at the rolling location, according to an embodiment of the present disclosure.

FIG. 9A illustrates an enlarged view of the rolling and releasing mechanism of FIG. 2, according to an embodiment of the present disclosure.

FIG. 9B illustrates the releasing mechanism according to an embodiment of the present disclosure.

FIG. 10A illustrates a side view of the releasing tray and cone shoe, according to an embodiment of the present disclosure.

FIG. 10B illustrates a top view of the releasing tray and cone shoe, according to an embodiment of the present disclosure.

FIG. 11 illustrates an air system and a glue system according to an embodiment of the present disclosure.

FIG. 12 is a schematic diagram of an operator control system, according to an embodiment of the present disclosure.

FIG. 13 illustrates a method of making a cone, according to an embodiment of the present disclosure.

It will be noted that throughout the appended drawings, like features are identified by like reference numerals.

### DETAILED DESCRIPTION

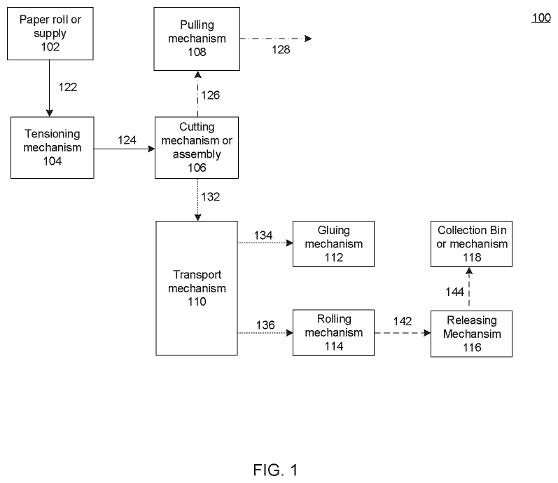

Embodiments provide for a cone rolling machine or apparatus configured to cut a cone blank from paper fed from a paper source and further configured to roll the cone blank into a cone. FIG. 1 illustrates a functional diagram of a cone rolling machine, according to an embodiment of the present disclosure. Referring to FIG. 1, apparatus 100 performs a number functions for making a cone from paper. Apparatus 100 includes a paper source 102 which may be a paper roll or bobbin filled with paper for supplying paper for making the cones. Paper from the paper roll 102 is pulled 126 by a pulling mechanism 108 as the apparatus 100 operates. The pulling force generated by the pulling mechanism 108 causes the bobbin 102 to rotate and unwind the paper, and the unwound paper is passed through a tensioning mechanism 104. The paper is passed through the tensioning mechanism 104 as illustrated by solid lines 122 and 124 and then passed through a cutting assembly or mechanism 106 illustrated by solid line 124 and dashed and dotted line 126. The paper is then passed through the pulling mechanism 108, dashed-dotted lines 126 and 128, out of the apparatus 100.

The tensioning mechanism 104 is configured to create a required tension in the paper or otherwise control the tension in the paper for the proper functioning of the apparatus, as the paper is continuously pulled. The cutting mechanism 106 is configured to cut a required shape from the paper as the paper is pulled through the cutting mechanism 106. The paper passing the cutting assembly, illustrated by dashed and dotted line 126, is the remaining paper after having the required shape cut from it. The remaining paper, which is a web of scrap paper, is then pulled through the pulling mechanism 108 and out of the apparatus as illustrated by dashed and dotted lines 126 and 128. As illustrated, solid lines 122 and 124 represent the path of the paper in its original or uncut form, and the dashed and dotted lines 126 and 128 represent the path of the scrap paper, after having the required shape cut.

At the cutting mechanism 106, a required shape is cut from the paper. The required shape cut from the paper may be referred to as a blank, and in the case of forming a cone or a truncated cone from the blank, the blank may be referred to as a cone blank. As the cone blank is cut, the cone blank is received, as illustrated by dotted line 110, by the transport mechanism 110. The transport mechanism 110 is further described elsewhere herein. The transport mechanism 110 transports, as illustrated by dotted line 134, the cone blank to the gluing mechanism 112. The gluing mechanism 112 is configured to apply the required glue to the cone blank as further described elsewhere herein.

After the gluing mechanism 112, the transport mechanism 110 is configured to transport, as illustrated by the dotted line 136, the cone blank with the applied glue to the rolling mechanism 114. The rolling mechanism 114 is configured to roll the cone blank into a cone as further described herein. As illustrated, the dotted lines 132, 134 and 136 represent the path of the cone blank.

After the rolling mechanism 114 forms a cone, the cone is transferred, as illustrated by dashed lines 142, to a releasing mechanism 116 as further described herein. The releasing mechanism 116 is configured to receive cones from the rolling mechanism 116 and further transfer or otherwise release, as illustrated by dashed lines 144, the received cones to the collection bin or mechanism 118, as further described herein. As illustrated, dashed lines 142 and 144 represent the path of cone after its formed.

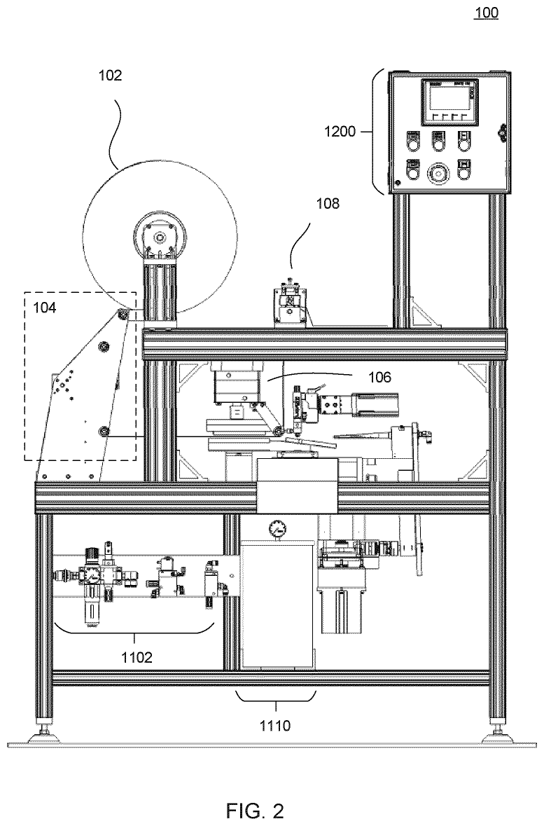

FIG. 2 illustrates a front view of a cone rolling machine of FIG. 1 assembled according to an embodiment of the present disclosure. Referring to FIG. 2, as discussed, the pulling mechanism 108, pulls the remaining paper having passed through the cutting mechanism 106. The paper is pulled from the paper roll 102 through the tensioning mechanism 104 and the cutting assembly 106 as illustrated.

Accordingly, during operation, the pulling force is applied to the portion of paper remaining after the cutting stage 106. The remaining paper, which is a web of paper having a pattern based on the shape that was removed, is pulled 126 by the pulling mechanism 108 and used to drive or otherwise turn the paper roll 102. Thus, the remaining paper should have a tensile strength sufficient to withstand the pulling force required to continue rotating the bobbin 102. In some embodiments, the tensile strength of remaining paper may be controlled by the width of the paper. Accordingly, a paper of a sufficient width is used to ensure that the remaining paper after the cutting stage can drive or otherwise rotate the bobbin 102.

As mentioned, apparatus 100 operates by pulling the paper through the different components 104 and 106. As may be appreciated by a person skilled in the art, operation by pulling allows for better control over the positioning of the paper as it moves passed through the different components. Since the pulling force is applied to the paper 126 that has passed the cutting stage, the positioning of paper along its path 122 and 124 or the length of paper passing through the different components is better controlled. Accordingly, the speed at which paper passes through the apparatus is better controlled.

A person skilled in the art may know of the various pulling mechanisms to employ for pulling paper through the apparatus 100. In an embodiment, the pulling mechanism 108 may include a motor for generating the pulling force or torque required for rotating the bobbin 102 and passing the paper through the apparatus.

In an embodiment, the pulling mechanism 108 applies a pulling force on the paper during operation. As may be appreciated by a person skilled in the art, the force required to continuously rotate the bobbin 102 steadily reduces as the diameter of the paper roll 102 reduces. Accordingly, to ensure that the speed at which paper is passed through the apparatus or otherwise have better control over such speed, the tensioning mechanism 104 is used. As the required rotating force is steadily decreased, the tensioning mechanism 104 is configured to generate a resistive force to balance the reduction in the required force to rotate the paper roll 102. The resistance generated by the tensioning mechanism 104 creates the required tension in the paper passing through the apparatus to allow for control over the speed at which the paper is passing.

In an embodiment, the pulling mechanism 108 may include two rollers that sandwich together on the paper and pull the paper a predetermined length, regardless of the force needed. As the paper is pulled, there may be slack. Accordingly, the tensioning mechanism 104 is configured to create a predetermined resistance in the paper to address the slack.

In other embodiments, the paper roll or bobbin 102 itself may be configured to unroll rather than being unrolled via the pulling mechanism 108. Accordingly, the paper roll 102 may be configured to rotate based on the amount of paper required. The rotation of the paper roll, in these embodiments, would be dependent on the changing diameter of the paper roll, as may be appreciated by a person skilled in the art.

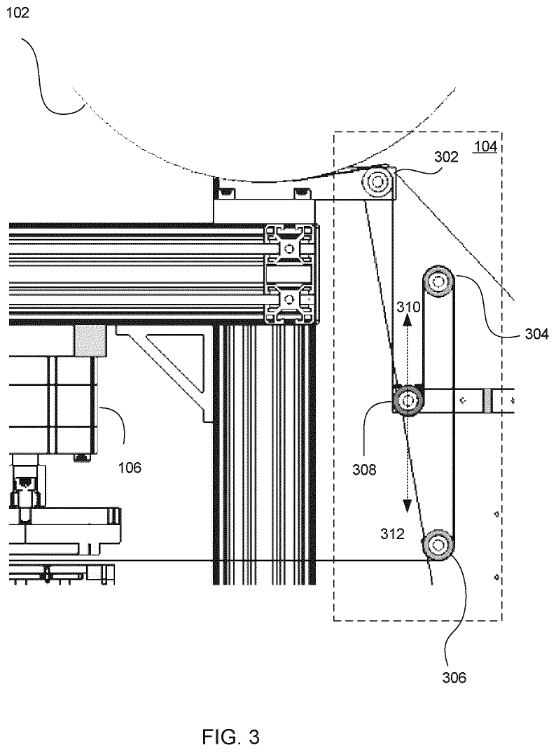

FIG. 3 illustrates a cross sectional view of the tensioning mechanism, according to an embodiment of the present disclosure. The illustrated view is a cross sectional view, viewed from back of the apparatus 100. The tensioning mechanism 104 may be a pulley system as illustrated. The pulley system may include three stationary or fixed pulleys 302, 304 and 306, and a third tensioning movable pulley or arm 308. During operation, the tensioning movable pulley 308 is continuously positioned, for example moving in directions 310 and 312, to maintain a relatively consistent tension in the paper. For example, as the paper roll diameter decreases, the tensioning movable pulley 308 is positioned to generate resistance equivalent to the decrease in force required to rotate the bobbin. For example, the tensioning movable pulley 308 may be lowered in direction 312. Accordingly, as the paper roll diameter is decreased, the resistance generated as a result of positioning the tensioning movable pulley 308 maintains a consistent tension in the paper during operation.

In an embodiment, the movement of the tensioning movable pulley 308 may be based on a predetermined resistance. The tensioning movable pulley 308 is configured to measure the tension in the paper as tension is applied, or otherwise the tensioning movable pulley 308 is configured to apply a predetermined tension based on a predetermined resistance. Accordingly, as the paper is pulled, the tensioning movable pulley 308 is moved in the required direction until the predetermined resistance is measured.

In some embodiments, the tensioning mechanism may include sensors to indicate the amount of paper left in the paper roll. There may be a relationship between the paper roll diameter and the position of the tensioning movable pulley 308 (or the generated resistance force) that may be sensed by the sensors. The sensor may notify an operator of the need to replace the paper roll. The sensors may further be configured to control the operation of the apparatus to prevent any damage that may occur.

In another embodiment, the pulling mechanism 108 may be configured to continuously reduce the pulling force applied on the paper as paper roll diameter reduces. In such embodiments, the tensioning mechanism 104 may be optional since the pulling mechanism 108 may be configured to create the required tension in the paper by steadily reducing the pulling force applied.

As mentioned, following the tensioning mechanism 104, paper is then passed through the cutting mechanism 106. A person skilled in the art may know of the various cutting mechanism that may be used for cutting a required shape out of paper.

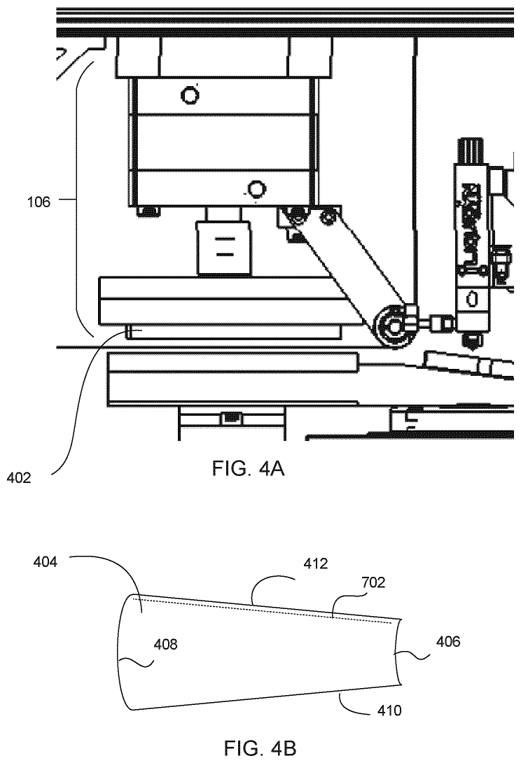

FIG. 4A illustrates an enlarged view of the cutting mechanism of FIG. 2, according to an embodiment of the present disclosure. In an embodiment, the cutting mechanism 106 may employ a die cutting method, in which a die 402 is formed to have the required shape for cutting such shape from the paper. The required shape may by the shape of an unrolled cone or unrolled truncated cone, such that when a cone is formed when the blank rolled. Accordingly, the cutting mechanism 106 is configured to cut cone blanks from the paper as the paper is passed through.

FIG. 4B illustrates a cone blank, according to an embodiment of the present disclosure. As discussed, the die 402 is formed to take the shape of cone blank 404 that will be rolled into a cone. The cone blank has an inner arc 406, an outer arc 408, a leading edge 410 and a lagging or trailing edge 412. The leading edge 410 is determined based on the direction of transport performed by the transport mechanism 110. The lagging edge 412 may be used a reference point for applying glue by the gluing mechanism 112, in which a thin line 702 of glue is applied as further described herein.

The die cutting method may be powered by hydraulics or may use servo control or servomotors as may be appreciated by a person skilled in the art. In some embodiments the die 402 may be a steel rule die for an improved cut. A person skilled in the art may appreciate that steel rule die cutting may allow for accurate and repeatable cutting with improved edge quality. In the case of a cone blank 404, the die 402 does not need to cut the paper on all edges or sides of the cone blank 404. However, cutting the paper on all four sides of the cone blank 406, 408, 410, and 412 improves the formation of the cone once the cone blank is rolled at the rolling stage 114. Cutting the paper on all four side allows for better alignment of the top and bottom of the cone.

Embodiments will now describe the transport mechanism 110. As the paper reaches the cutting stage 106, a cone blank 404 is cut.

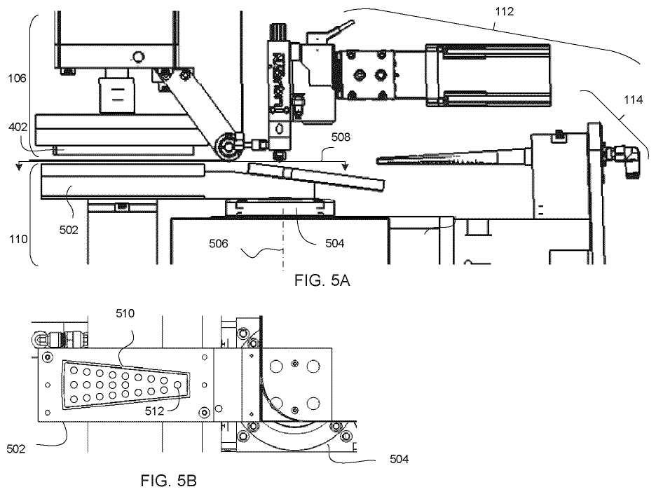

FIG. 5A illustrates an enlarged view of FIG. 2 including the cone shoe (the transport mechanism) and other apparatus components, according to an embodiment of the present disclosure. FIG. 5B illustrates a top view of the cone shoe of FIG. 5A, according to an embodiment of the present disclosure. The view in FIG. 5B is a top view of the transport mechanism 110 based on line 508 of FIG. 5A.

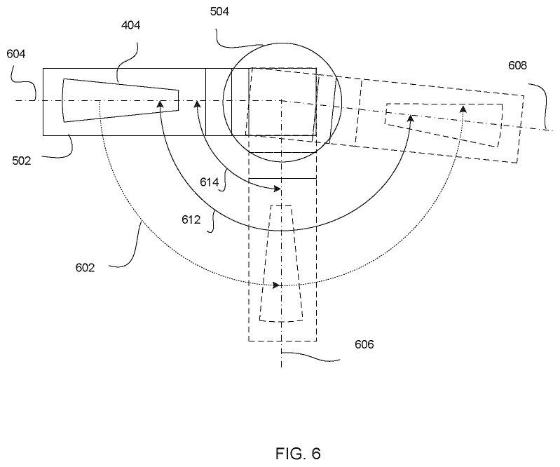

Once the cone blank 404 is cut, the cone blank is transferred to the transport mechanism 110. While the cone blank 404 is being cut, the cone shoe 502 is configured to receive and hold the cone blank 404 in a predetermined position 510 on the cone shoe 502. Holding the cone blank 404 while it is being cut may improve the cutting accuracy and further prevent the cone blank 404 from being blown away. As may be appreciated by a person skilled in the art, the cone shoe 502 is positioned or located under the paper and aligned with the cutting die 402 to receive the cone blank 404, as illustrated, and this position or location of the cone shoe may be referred to as the cutting position or location (604 in FIG. 6). The cone shoe 502 is further configured to transport the cone blank (while held in the predetermined position 510) to the gluing stage 112 and the rolling stages 114. Accordingly, the cone blank 404 does not move after it is cut and during transport.

A person skilled in the art may know of various methods for holding the cone blank 404 in the predetermined position 510. In an embodiment, the cone blank may be held in the predetermined position 510 via a pneumatic system. In another embodiment, the cone blank may be sufficiently held in the predetermined position 510 using materials with properties that improve the temporary bond, such as silicones, cork board, or static bearing material. The cone shoe 502 may have a plurality of holes 512 for using compressed air in vacuum form to hold the cone blank 404 in place during cutting and for transport. It should be noted that the holding mechanism, i.e., the vacuum force or pull, in the predetermined position 510 is activated while the cone blank is being cut, at the cutting position, and released as the cone blank 404 is transferred to the rolling mechanism 114.

The cone shoe 502 or otherwise the transport mechanism 110 may be configured to transport the cone blank 404 by rotating about an axis 506 (referring to FIG. 5A). The various methods by which the cone shoe 502 may rotate may be known by a person skilled in the art. In an embodiment, the cone shoe 502 may be attached to a rotating component 504 for controlling the rotation of the cone shoe 502 or otherwise the transport of the cone blank 404. In an embodiment the rotating component is driven by a controllable motor.

FIG. 6 illustrates a top view of the cone shoe's rotation during transport of the cone blank 404, according to an embodiment of the present disclosure. As mentioned, the cone shoe 502 transports the cone blank 404, from the cutting position 604, to the gluing position, at 606, for applying the glue by the gluing mechanism 112. Thereafter, the cone shoe is configured to transport the cone blank 404 to the rolling or transfer location, at 608, for rolling the cone blank 404 by the rolling mechanism 114. The path of the cone blank 404 may be referred to as the transport path 602.

The gluing stage may be at an appropriate location (gluing location 606) along the transport path 602 between the cutting location 604, where the cone blank is received, and the rolling or transfer location 608, where the cone blank is transferred. The gluing mechanism 112 is calibrated based on the predetermined position 510 of the cone blank 404 on the cone shoe 502 at the gluing location 606.

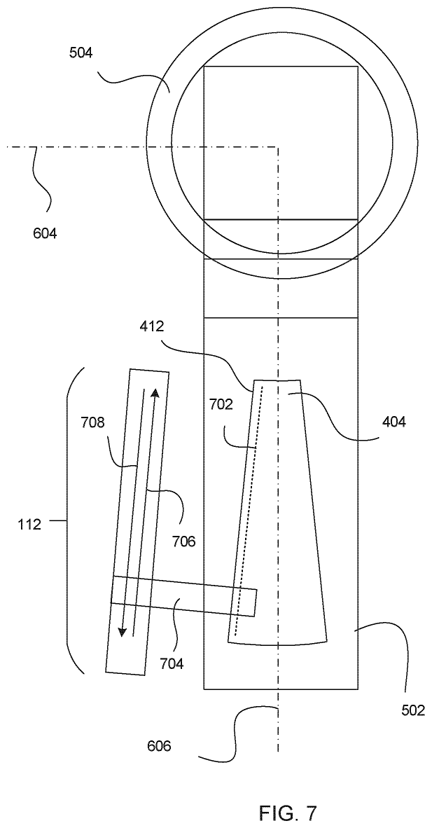

FIG. 7 illustrates the cone shoe at the gluing location, according to an embodiment of the present disclosure. At the gluing location 606, the cone blank 404 is underneath the gluing mechanism 112. Accordingly, once the cone shoe 502 or otherwise the cone blank 404 reaches the gluing location 606, the gluing mechanism 112 applies glue to the cone blank 404. A bead of glue or a thin (for example 0.8 mm wide) line of glue 702, may be applied on the lagging side or edge 412 of the cone blank 404. The types of glue that may be used are also be known by a person skilled in the art. In an embodiment, wet glue, rather than dry glue is used. A person skilled in the art may appreciated that EVA (typical white kraft glue) or Arabic gum (dried tree sap) may also used.

There may be various methods for applying glue known by a person skilled in the art. One method may be based on the glue pressure and nozzle size, in which the glue pressure and nozzle size determine the amount, including the line thickness, of glue that is applied. This method may be referred to an open-closed method. Using such a method, although may work, may not be feasible as the speed at which glue is applied is limited, and the glue line may be too thick leading to inaccurate application of the glue.

In another embodiment, the gluing mechanism 112 may use a dispensing valve for dispensing glue on the cone blank. The dispensing valve may have its own limitation, such as limited dispensing velocity and limited control over the thickness of the applied glue.

In another embodiment, the gluing mechanism 112 may use a piezo-based jetted valve 704 otherwise referred to as a dosing valve or gun for dispensing glue or adhesive on the cone blank. Piezo-based jetted valves may allow for quick and accurate dispensing (99%) of glue while preventing glue drippage. The Piezo-based jetted valves may allow for dispensing or ejecting very tiny volumes at high velocities (dispensing time—opening and closing—up to 0.8 ms and dispensing frequencies up to 600 Hz). The desired glue line 702 thickness is determined by the amount of paper overlap (glue area) and is calibrated or configured using change parts such as glue nozzle size and a PLC-HMI to control the velocity of the dispensing valve (through transport servo) and the volume of glue per dot (dose). In another embodiment, where a piezo-based technology is not used, the desired glue line 702 thickness is calibrated or configured using change parts such as glue nozzle size, a PLC-HMI to control the velocity of the dispensing valve and cycle rate (open/closed), and a pressure regulator on the glue line-in to control the glue pressure while cycle is ‘open’.

As mentioned, the glue is applied to the lagging edge 412 of the cone blank 404. The dispensing valve 704, for example the piezo-based jetted valve, may move along the lagging edge 412 of the cone blank 404, in one motion 706 or 708, as a thin line 702 of glue is applied.

In another embodiment, the glue mechanism 112 may be implemented prior to the cutting mechanism 106. In this embodiment, glue may be applied to a large sheet of paper since the paper is not yet cut (rather than applying glue to individual blanks after the cutting stage). Applying glue prior to the cutting mechanism 106 may pose issues, however, including dealing with glue remains on the die 402 and other components that may come in contact with the applied glue.

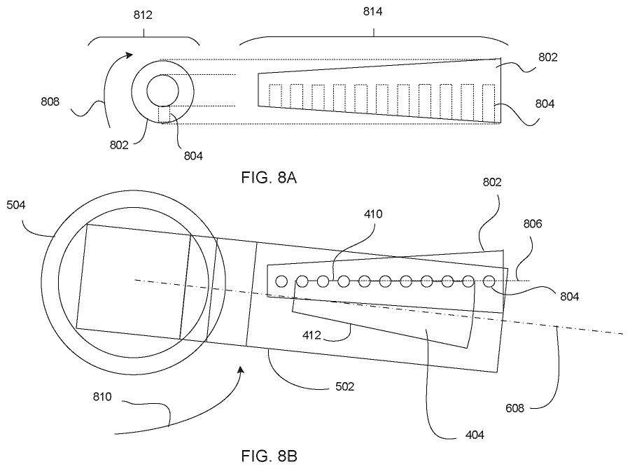

FIG. 8A illustrates a rolling mandrel according to an embodiment of the present disclosure. FIG. 8B illustrates the cone shoe 502 at the rolling location, according to an embodiment of the present disclosure.

After glue is applied to the cone blank 404, the cone shoe 502 transports the cone blank 404, while held in the predetermined position 510, to the rolling location 608. As may be appreciated by a person skilled in the art, the rolling mechanism 114 has a rotational speed that is calibrated or controlled based on the rolling mandrel 802 outside diameter and the rotational speed of the cone shoe 502 as further described herein. A person skilled in the art may appreciate that a thicker mandrel would be required to rotate slower, relative to a thinner mandrel which would have to rotate faster.

The rolling mechanism 114 includes a rotating or rolling cone shaped mandrel 802 around which the cone blank 404 is rolled into a cone. Referring to FIG. 8A, a side view 814 and a front view 812 of the rolling mandrel 802 is illustrated. As the cone shoe 502 is passed under the rolling mechanism 118 on the transport path 602, the cone blank 404 is transferred from the cone shoe 502 to the rolling mandrel 802. In an embodiment, the rolling mandrel 802 may employ a pneumatic system for receiving the cone blank 404. The rolling mandrel 802 includes a plurality of holes 804 in a linear pattern along the length of the rolling mandrel 802. The rolling mechanism 114 uses a vacuum force applied through the plurality of holes 804 along the length of rolling mandrel 802 to receive and hold the cone blank 404. In an embodiment, the rolling mandrel receives and holds the cone blank 404 from its leading edge 410 as the cone shoe 502 arrives at the transfer or rolling location 608, at which point, the rolling mandrel's length or otherwise the plurality of linear holes 804 along the rolling mandrel's length aligns with the leading edge 410 of the cone blank 404 (alignment line 806). The alignment of the plurality of holes 804 of the rolling mandrel 802 with the leading edge 410 of the cone blank 404 on the cone shoe 502 is illustrated by the line 806. As illustrated the alignment line 806 is ahead of the transfer location 608 since, the alignment line is based on the leading edge 410 of the cone blank 404.

As the cone shoe 502 reaches the transfer or rolling location 608 (which is the point at which the plurality of holes 804 are aligned with the leading edge 410 of the cone blank 404—line 806) the vacuum force from the rolling mandrel 802 is activated or otherwise configured (through the plurality of holes 804) to receive and hold the cone blank 404, from its leading edge 410 while the vacuum force of the cone shoe 502 acting near the leading edge 410 of the cone blank is released.

The application of vacuum force in the rolling mandrel 802 is calibrated or controlled or otherwise synchronized with the release of the vacuum force in the cone shoe 502 as the cone shoe 502 passes the transfer location 608. As the rolling mandrel 802 rotates, the cone blank 404 is released from the cone shoe 502, via the release of the vacuum force in the cone shoe 502 as the lagging edge 412 of the cone blank 404 passes the alignment line 806. The cone blank rolls around the rolling mandrel 802 simultaneously as the cone blank 404 leaves the cone shoe 502. Accordingly, the cone blank 404 is continuously held, during transfer, by vacuum forces of the rolling mandrel 802 and the cone shoe 502. As the lagging edge 412 of the cone blank 404 is released from the cone shoe 502 and rolled around the rolling mandrel 802, the thin line of glue 702 comes in contact with the surface of the now formed cone, thereby gluing the lagging edge to the cone's surface.

In an embodiment, the rolling mandrel 802 may be driven by a controllable motor. The controllable motor may be the same motor that drives the rotating component 504.

A person skilled in the art may appreciate that during the transfer of the cone blank 404 (from the cone shoe 502 to the rolling mandrel 802) the rotational speed of the cone shoe 502 should be calibrated with the rotation speed of the rolling mandrel 802 for proper formation of the cone. As may be appreciated by a person skilled in the art, the rotational direction 808 of the rolling mandrel 802 should match the rotational direction 810 of the cone shoe.

The calibration of the rotational speeds should be such that the cone blank 404 is smoothly transferred to and rolled around the rolling mandrel 802. Smooth transfer of cone blank should not be interpreted as slow transfer, rather smooth transfer is based on optimal rotational speeds of the cone shoe 502 and the rolling mandrel 802 that permits adequate formation of the cone around the rolling mandrel 802. Poor calibration may lead to inadequate cone formation. The calibration of rotational speeds of the rolling mandrel 802 and the cone shoe 502 may be implemented via a gear system as may be appreciated by a person skilled in the art. For example, a gear system with the required gear ratio may be used to implement the required calibration. In addition to the gear system, a belt drive system, used to drive the rolling mandrel 802, may provide an additional degree of calibration or control over the rotational speed of the rolling mandrel 802.

Further, the calibration of the rotational speeds should be applied at least during the transfer time. The transfer time may begin when the leading edge 410 of the cone blank 404 aligns with the plurality of holes 804 of the rolling mandrel 802 (the alignment line 806)—when the cone shoe arrives at the transfer or rolling location 608. The transfer time may end when the lagging edge 412 of the cone blank 404 passes the alignment line 804. During the transfer time, the rotational speed of the cone shoe 502 should be configured to carry, for example, the leading edge 410 of the cone blank 404 a distance equivalent to the distance that the leading edge 410 is carried by the rolling mandrel 802 during the transfer time. Rotational speed of either or both of the cone shoe 502 and the rolling mandrel 802 may be calibrated or configured to achieve the optimal speed. A safety factor may be applied to lengthen the transfer time for ensuring proper cone formation.

The rolling mandrel 802 may be driven by various methods known by a person skilled in the art. In an embodiment, the rolling mandrel 802 may be belt driven using a common motor that drives the rotating component 504.

A person skilled in the art may appreciate that to be able to form the cone around the rolling mandrel 802, at least two points of contact may be needed. Accordingly, in another embodiment, the rolling mechanism 114 may include a second rolling mandrel positioned in parallel but in opposite direction (flipped 180°) to the rolling mandrel 802. The second rolling mandrel may create a pinch with the first rolling mandrel for creating the required points of contact for rolling the cone blank.

In some embodiments, following the formation of the cone at the rolling mandrel 802, the glue used to form the cone may be wet for a period of time after cone formation. Accordingly, the apparatus 100 may include a drying mechanism configured to receive and cure or dry the glue/adhesive after the cone is rolled. In some embodiments, the drying mechanism may include a mandrel, which may be referred to as a drying mandrel. The drying mandrel may be configured to receive the formed cone from the rolling mandrel 802 and hold the cone during a drying period. The drying period may a reasonable time required for the glue to dry or to reach a state such that the form of the cone is maintained if released from the drying mandrel. In other embodiments, the drying mechanism may be a drying chamber. After the cones are rolled, the cones are passed under a drying chamber. The design of the drying chamber may be based on the drying period to ensure that the cones are adequately cured/dried before collection.

It should be noted that the cone formation time may also be similar to the transfer time, since the cone formation begins as the cone is transferred from the cone shoe 502 to the rolling mandrel 802. Upon formation of the cone, the vacuum force in the mandrel is released. According, after the cone shoe is passed the rolling mandrel or otherwise the rolling mechanism 114, the cone is formed and all vacuum forces (in the rolling mandrel and the cone shoe) are released or otherwise disengaged.

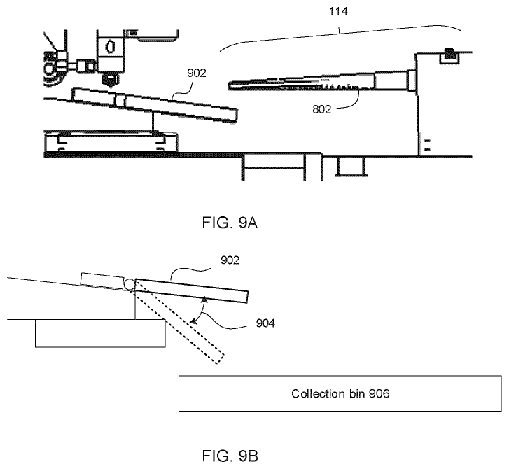

FIG. 9A illustrates an enlarged view of the rolling and releasing mechanism of FIG. 2, according to an embodiment of the present disclosure. FIG. 9B illustrates the releasing mechanism according to an embodiment of the present disclosure.

After transferring the cone blank 404 to the rolling mandrel 802, the cone shoe 502 continues to rotate about the rotating component 504 towards the cutting position 604 for receiving another cone blank 404. At the same time, the cone formed on the rolling mandrel 802 may be ejected, via, for example air, from the rolling mandrel onto a releasing tray 902.

In some embodiments, the releasing tray 902, may have a releasing or transferring mechanism for releasing or transferring the received cones into a collection tray or bin 906. The releasing tray 902 may be adjustably tilted 904 to release or transfer the received cones into the collection bin 906. There may be other methods known by a person skilled in the art for transferring the received cones from the releasing tray 902 to the collection bin 906.

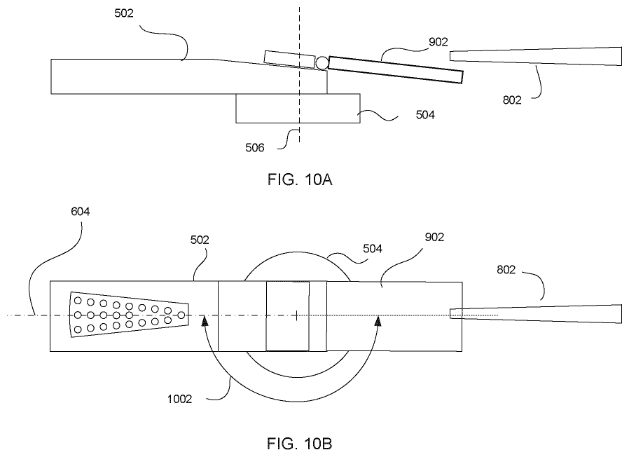

In some embodiments the releasing tray 902 may be mounted to the same rotating component 504 that rotates the cone shoe 502. FIG. 10A illustrates a side view of the releasing tray and cone shoe, according to an embodiment of the present disclosure. FIG. 10B illustrates a top view of the releasing tray and cone shoe, according to an embodiment of the present disclosure. The releasing tray 902 may be separate or attached (in the case of FIGS. 10A and 10B) to the cone shoe 902. Accordingly, as the cone shoe 502 rotates (about axis 506), the releasing tray 902 also rotates about the axis 506. The angle (in the plane of rotation) that the releasing tray 902 makes with cone shoe 502 (releasing-tray-cone-shoe angle 1002) may vary as may be appreciated by a person skilled in the art. In an embodiment this angle 1002 may be close to 180°.

In some embodiments the releasing tray 902 may hold one cone at a time. In such embodiments, the releasing tray drops or releases the cone into the collection bin 906 before receiving the next cone. In other embodiments the releasing tray 902 may hold more than one cone at a time before releasing the more than one cones into the collection bin 906. As mentioned, the releasing tray 902 is configured to have an adjustable tilt 904 (which may be controlled) for releasing the one or more cones into the collection bin 906. Accordingly, the collection bin may be positioned at a point along the rotational path of the releasing tray.

As mentioned elsewhere herein, the rolling mechanism 114 is positioned after the gluing mechanism 112 along the transport path 602 (referring to for example, FIG. 6). Accordingly, the positioning of the rolling mandrel 802 (line 806) at a point along the cone blank path (transport path 602) or the degree of rotation in reference to the cutting position 604 (in the plane of the rotation of the cone shoe) for the cone shoe 502 to rotate to reach the transfer location 608 (transfer degree of rotation 612) may vary as may be appreciated by a person skilled in the art. Similarly, the gluing mechanism 112 or the degree of rotation in reference to cutting position 604 (in the plane of the rotation of the cone shoe) for the cone shoe 502 to rotate to reach the gluing location 606 (gluing degree of rotation 614) may also vary.

In an embodiment, the transfer degree of rotation 612 may be at slightly less than 180° and the gluing degree of rotation 614 may be at 90° as illustrated in FIG. 6.

Accordingly, in an embodiment in which the releasing-tray-cone-shoe angle 1002 is nearly 180° (such as in FIG. 10B) and the transfer degree of rotation 612 is slightly less than 180° (such as in FIG. 6), when the cone shoe 502 is at the cutting position 604 (under the die) the releasing tray 902 may be relatively aligned with the rolling mandrel 802—assuming the rolling mandrel 802 is positioned at near 180° (in the plane of rotation of the cone shoe) from the cutting position 604. The rolling mandrel's position may refer to line 806 of FIG. 8B, in which line 806 is slightly ahead of line 608, the transfer location. Assuming that a cone is already formed at the rolling mandrel 802, as the cone shoe 502 reaches the cutting position 604, the formed cone is ejected from the rolling mandrel 802 and transferred to the releasing tray 902—the releasing tray being aligned with the rolling mandrel when the cone shoe is at the cutting position (illustrated in FIG. 10B). Then, as the cone shoe receives the next cone blank, the cone shoe rotates with the releasing tray 902.

In an embodiment, as the next cone shoe 502 reaches the gluing location 606 and the transfer location 608, the releasing tray 902 continues to hold the cone previously received. Assuming, the releasing tray 902 is configured to hold one cone at a time, then at some point before receiving the next cone, the releasing tray 902 releases, via a releasing mechanism 904, the cone previously received into the collection bin 906. The releasing tray 902 continues to rotate and as it aligns with the rolling mandrel 802, having formed the next cone, the next cone is ejected from the rolling mandrel 802 onto the releasing tray 902.

Accordingly, as mentioned in reference to FIG. 1, the paper path begins at the paper roll 102, passes through the tensioning mechanism 104 and arrives at the cutting mechanism 106 (lines 122 and 124). The remainder portion of the paper is pulled through the pulling mechanism 106 and out of the apparatus (lines 126 and 128). The cone blank path begins at the cutting mechanism 106 in which the cone blank is held by the cone shoe 502 and transferred to the gluing location 606 and thereafter to the transfer location 608, at which point the cone blank path ends. The cone blank path may refer to the transport path 602 of FIG. 6 and lines 132, 134 and 136 of FIG. 1. The cone path begins at the rolling mandrel 802 around which the cone is formed. The cone is ejected onto the releasing tray 902 and transported along the releasing tray's path until released into the collection bin 906—referring to lines 142 and 144 of FIG. 1.

As may be appreciated by a person skilled in the art, the apparatus 100 allows for continuous formation and collection of cones. The continuous operations performed include cutting of the cone blank 404, gluing (the lagging edge 412) of the cone blank, transferring of the cone blank 404 to the rolling mandrel 802, rolling the cone blank into a cone, ejecting the formed cone onto a releasing tray 902 and releasing the formed cone to a collection bin 902. The positioning of the different components including the gluing location 606 (gluing degree of rotation 614), the transfer location 608 (transfer degree of rotation 612), and the releasing-tray-cone-shoe angle 1002 may be optimized for improved operation of the apparatus as whole.

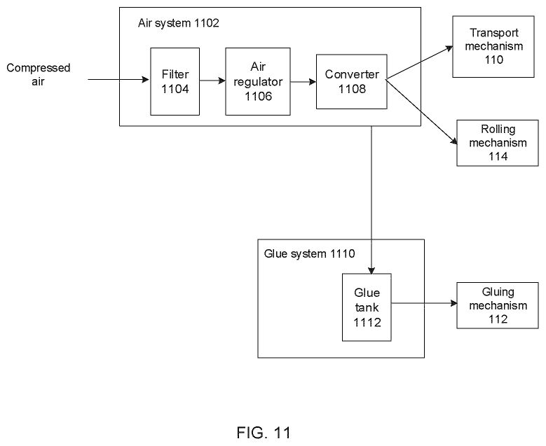

FIG. 11 illustrates an air system and a glue system according to an embodiment of the present disclosure.

The apparatus 100 further includes an air system 1102 for providing vacuum forces necessary for the transport mechanism 110 (the cone shoe 502) and the rolling mechanism 114 (the rolling mandrel 802). A person skilled in the art may know of various methods for providing the vacuum force. In an embodiment, the air system includes a filter 1104 for receiving compressed air from, for example, a compressor. The air system further includes an air regulator 1106 for controlling the air pressure that is being supplied. The air regulator 1106 is connected to the filter 1104 and a converter 1108. The converter 1108 is configured to convert the compressed air to vacuum air for generating the vacuum force required for the transport mechanism 110 and rolling mechanism 114. The converter 1108 is connected to the transport mechanism 110 and the rolling mechanism 114 via, for example, controllable hoses, to provide the required vacuum. An illustration of the air system 1102 as part of the apparatus 100 is shown in FIG. 2.

The apparatus 100 further includes a glue system 1110 for suppling glue or adhesive to the glue mechanism 112. The glue system includes a glue tank 1112 for holding and supply glue to the piezo-based jetted valve 704 used to apply glue. The glue tank 1112 uses pressure to push glue out of the tank, and the pressure may be generated from the air system 1102. Accordingly, the air system 1102 is connected to the glue system 1110 to supply the required pressure for supplying glue to the gluing mechanism 112. The glue tank 1112 may include a second regulator to have isolated control over the pressure in the glue tank 1112. In some embodiments, the glue tank 1112 may include sensors for tracking the volume of glue in the tank and notifying an operator for replacement. The sensors may further be configured to control the operation of the apparatus to prevent any damage that may occur. An illustration of the glue system 1110 as part of the apparatus 100 is shown in FIG. 2.

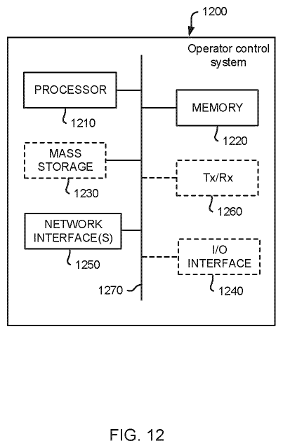

FIG. 12 is a schematic diagram of an operator control system, according to an embodiment of the present disclosure. The apparatus includes operator control system 1200, which may include a processor 1210, such as a central processing unit (CPU) or specialized processors such as a graphics processing unit (GPU) or other such processor unit, memory 1220, non-transitory mass storage 1230, input-output interface 1240, network interface 1250, and a transceiver 1260, all of which are communicatively coupled via bi-directional bus 1270. According to certain embodiments, any or all of the depicted elements may be utilized, or only a subset of the elements. Further, the operator control system 1200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1220 may include any type of non-transitory memory such as static random access memory (SRAM), dynamic random access memory (DRAM), synchronous DRAM (SDRAM), read-only memory (ROM), any combination of such, or the like. The mass storage element 1230 may include any type of non-transitory storage device, such as a solid state drive, hard disk drive, a magnetic disk drive, an optical disk drive, USB drive, or any computer program product configured to store data and machine executable program code. According to certain embodiments, the memory 1220 or mass storage 1230 may have recorded thereon statements and instructions executable by the processor 1210 for performing any of the aforementioned operations described above.

In an embodiment the operator control system 1200 may operate as a programmable logic controller (PLC) and the I/O interface 1240 may be a human-machine-interface (HMI). PLC may be configured for continuously monitoring the state of the apparatus and make decisions as appropriate. For example, the PLC may control the apparatus based on notification received from sensors used in the apparatus. The HMI allows for an operator to interact with the apparatus. The HMI my provide checks and control over the apparatus 100, in addition to insights into performance and progress of the apparatus. The HMI may communicate with the PLC to receive and display information for the operator, and to monitor and control PLC functions. An illustration of the operator control system 1200 as part of the apparatus 100 is shown in FIG. 2.

In some embodiments, the operator control system 1200 includes two instances of HMIs and PLCs. The first HMI-PLC may be configured to control the operation of the glue system and the glue mechanism. The second HMI-PLC may be configured to control the rest of the apparatus, including the air system and other operations as discussed herein.

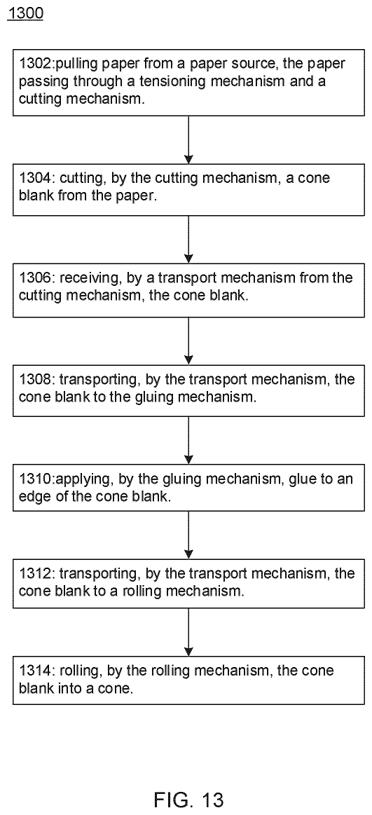

FIG. 13 illustrates a method of making a cone, according to an embodiment of the present disclosure. The method 1300 may include, at 1302, pulling paper from a paper source, the paper passing through a tensioning mechanism and a cutting mechanism. The method may further include, at 1304, cutting, by the cutting mechanism, a cone blank from the paper. The method may further include, at 1306, receiving, by a transport mechanism from the cutting mechanism, the cone blank. The method may further include, at 1308, transporting, by the transport mechanism, the cone blank to the gluing mechanism. The method may further include, at 1310, applying, by the gluing mechanism, glue to an edge of the cone blank. The method may further include, at 1312, transporting, by the transport mechanism, the cone blank to a rolling mechanism. The method may further include, at 1314, rolling, by the rolling mechanism, the cone blank into a cone.

In some embodiments, the method 1300 may further includes applying tension to the paper as the paper is being pulled, the tension applied to maintain a consistent tension in the paper. In some embodiments, the method may further include transferring, by the rolling mechanism, the cone to a releasing mechanism. In some embodiments, the method may further includes receiving, by the releasing mechanism from the rolling mechanism, the cone. In some embodiments, the method may further include releasing, by the releasing mechanism into a collection bin, the cone. In some embodiments, the cutting comprises cutting the cone blank using a die. In some embodiments, the die is a steel-rule die. In some embodiments, the applying comprises using a piezo-based valve to apply glue, and wherein the edge of the cone blank is a lagging edge. In some embodiments, the transport mechanism uses a pneumatic system to hold the cone blank during transportation. In some embodiments, the transport mechanism transports the cone blank by rotating about an axis. In some embodiments, the rolling mechanism is a rolling mandrel. In some embodiments, the rolling mechanism uses a pneumatic system to receive from the transport mechanism the cone blank and roll the cone blank into a cone.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Positional and directional terms are used to reference to the illustrated embodiments in the drawings to which reference is made unless otherwise stated. Moreover, all representations described herein are intended solely to be by way of example for purposes of illustrating certain embodiments and are not intended to limit the scope of the disclosure to any embodiments that may depart from such representation as may be described.

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In particular, features from one or more of the above-described embodiments may be selected to create alternative embodiments comprised of a sub-combination of features that may not be explicitly described above. In addition, features from one or more of the above-described embodiments may be selected and combined to create alternative embodiments comprised of a combination of features that may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1-20. (canceled)

21. A cone rolling machine comprising:
a pulling mechanism configured to pull paper from a paper source, the paper passing through a tensioning mechanism and a cutting mechanism;
the tensioning mechanism configured to maintain a consistent tension in the paper as the paper passes through the tensioning mechanism and the cutting mechanism;
the cutting mechanism configured to cut a cone blank from the paper;
a transport mechanism configured to receive the cone blank from the cutting mechanism and transport the cone blank to a gluing mechanism and thereafter to a rolling mechanism;
the gluing mechanism configured to apply glue to an edge of the cone blank; and the rolling mechanism configured to receive the cone blank from the transport mechanism and roll the cone blank into a cone.

22. The cone rolling machine of claim 21 further comprising:
a releasing mechanism configured to receive the cone from the rolling mechanism and release the cone into a collection bin.

23. The cone rolling machine of claim 21, wherein the tensioning mechanism comprises a pulley system of at least four pulleys, including three stationary pulleys and a movable pulley configured to create tension.

24. The cone rolling machine of claim 21, wherein the cutting mechanism is based on die cutting, wherein the die is a steel rule die.

25. The cone rolling machine of claim 21, wherein the transport mechanism uses a pneumatic system for holding the cone blank in a predetermined position during transport.

26. The cone rolling machine of claim 21, wherein the transport mechanism transports the cone blank by rotating around an axis.

27. The cone rolling machine of claim 21, wherein the gluing mechanism uses a piezo-based valve to apply glue.

28. The cone rolling machine of claim 21, where the edge of the cone blank is a lagging edge.

29. The cone rolling machine of claim 21, wherein the rolling mechanism is a rolling mandrel.

30. The cone rolling machine of claim 29, wherein the rolling mandrel uses a pneumatic system to receives the cone blank from the transport mechanism.

31. A method of rolling a cone, the method comprising:
pulling paper from a paper source, the paper passing through a tensioning mechanism and a cutting mechanism;
cutting, by the cutting mechanism, a cone blank from the paper;
receiving, by a transport mechanism from the cutting mechanism, the cone blank;
transporting, by the transport mechanism, the cone blank to the gluing mechanism; applying, by the gluing mechanism, glue to an edge of the cone blank;
transporting, by the transport mechanism, the cone blank to a rolling mechanism; and
rolling, by the rolling mechanism, the cone blank into a cone.

32. The method of claim 31 further comprising:
applying tension to the paper as the paper is being pulled, the tension applied to maintain a consistent tension in the paper.

33. The method of claim 31 further comprising:
transferring, by the rolling mechanism, the cone to a releasing mechanism; receiving, by the releasing mechanism from the rolling mechanism, the cone; and releasing, by the releasing mechanism into a collection bin, the cone.

34. The method of claim 31, wherein the cutting comprises cutting the cone blank using a die.

35. The method of claim 34, wherein the die is a steel-rule die.

36. The method of claim 31, wherein the applying comprises using a piezo-based valve to apply glue, and wherein the edge of the cone blank is a lagging edge.

37. The method of claim 31, wherein the transport mechanism uses a pneumatic system to hold the cone blank during transportation.

38. The method of claim 31, wherein the transport mechanism transports the cone blank by rotating about an axis.

39. The method of claim 31, wherein the rolling mechanism is a rolling mandrel.

40. The method of claim 31, wherein the rolling mechanism uses a pneumatic system to receive from the transport mechanism the cone blank and roll the cone blank into a cone.
